(19) United States
(12) Patent Application Publication
(10) Pub. No.: US 2025/0250992 A1
(43) Pub. Date: Aug. 7, 2025

(54) CEILLING FAN AND QUICK-MOUNTING BRACKET STRUCTURE THEREOF

(71) Applicant: TAISHAN SIGMA ELECTRIC PRODUCTS CO., LTD, Jiangmen City (CN)

(72) Inventors: Shaoquan HUANG, Jiangmen City (CN); Xinzhu Zheng, Jiangmen City (CN); Ka Meng Wong, Jiangmen City (CN)

(21) Appl. No.: 18/913,226

(22) Filed: Oct. 11, 2024

(30) Foreign Application Priority Data
Feb. 2, 2024 (CN) 202420270787.2

(51) Int. Cl. F04D 29/64; F04D 19/00; F16M 13/02

(52) U.S. Cl. CPC F04D 29/646; F04D 19/002; F16M 13/027

(57) ABSTRACT

Provided is a ceiling fan and a quick-mounting bracket structure, comprising a junction box provided with a first mounting hole; a fastener comprising a fastening head and a fastening shaft, wherein a bottom end of the fastening shaft being pre-installed within the first mounting hole; a stopper fitted over the fastening shaft; a bracket provided with a mounting portion where an aligning hole and a second mounting hole communicating with the aligning hole are provided, wherein a diameter of the aligning hole is no less than that of the stopper, and a diameter of the second mounting hole is less than that of the stopper; and the bracket further comprises an aligning position and a fixing position. The advantage of the present disclosure is that the installation is simplified, enhancing convenience for installers and reducing installation time.

### CROSS-REFERENCE TO RELATED APPLICATIONS

This application claims priority under 35 U.S.C. § 119 to Chinese Application No. 202420270787.2, having a filing date of Feb. 2, 2024, the entire contents of which are hereby incorporated by reference.

### FIELD OF TECHNOLOGY

The following relates to the technical field of a ceiling fan, particularly, it relates to a ceiling fan and a quick-mounting bracket structure.

### BACKGROUND

To install a ceiling fan, an installer needs to lift the bracket to the bottom of the junction box which is typically pre-embedded within the ceiling, and align the threaded holes on the bracket with those on the junction box, and then screw in the threaded holes by bolts, such that the bracket can be installed and fixed to the junction box.

The above-mentioned arrangement for installing the bracket to the junction box needs to align the threaded holes on the bracket with those on the junction box, and then screw in the corresponding bolt through the threaded holes of the bracket and junction box. Typically, two sets of threaded holes are employed for fixation. First, a first set of threaded holes is aligned and screwed in by a bolt, followed by alignment and screwing in of another bolt for the other set of threaded holes. Finally, both of bolts are screwed and fixed simultaneously. This installing method can be inconvenient and time-consuming for installers during installation.

### SUMMARY

In order to overcome the above-mentioned technical defeats, an aspect of the present disclosure relates to a ceiling fan and a quick-mounting bracket structure thereof, to solve the problem with the installation of the bracket.

The present disclosure is achieved according to the following technical solution.

An aspect relates to a quick-mounting bracket structure, comprising:
a junction box provided with a first mounting hole;
a fastener comprising a fastening head and a fastening shaft, wherein a bottom end of the fastening shaft is pre-installed within the first mounting hole;
a stopper fitted over the fastening shaft;
a bracket provided with a mounting portion where an aligning hole and a second mounting hole communicating with the aligning hole are provided, wherein a diameter of the aligning hole is no less than the that of the stopper, and a diameter of the second mounting hole is less than that of the stopper; and
the bracket further comprises an aligning position and a fixing position; when the bracket is located at the aligning position, the stopper and the fastening head are inserted through the aligning hole of the bracket; when the bracket is located at the fixing position, the fastener is screwed in such that an upper surface of the stopper abuts against the bracket and a lower surface of the stopper abuts against the fastening head.

The process of installing and fixing the bracket to the junction box involves the following steps. Initially, the fastener is pre-installed within the first mounting hole of the junction box, and then the stopper and the fastening head are inserted through the aligning hole of the bracket, such that the bracket is located at the aligning position. Subsequently, the bracket is moved from the aligning position to the fixing position. And finally, the fastener is screwed in such that the upper surface of the stopper abuts against the bracket and the lower surface of the stopper abuts against the fastening head. The advantage of the present disclosure is achieved by pre-installing the fastener in the junction box, then simply installing the bracket onto the junction box and finally fixing the fastener, thereby enabling quick installation. Moreover, this eliminates the process of aligning the threaded holes and then screwing in the whole bolt in the prior art, simplifying the installation, enhancing convenience for installers and reducing installation time.

Another aspect of the present disclosure relates to a quick-mounting bracket structure, comprising:
a junction box provided with a first mounting hole;
a fastener comprising a fastening head and a fastening shaft, wherein a bottom end of the fastening shaft is pre-installed within the first mounting hole;
a bracket provided with a mounting portion where an aligning hole and a second mounting hole communicating with the aligning hole are provided, wherein a diameter of the aligning hole is no less than that of the fastening head, and a diameter of the second mounting hole is less than that of the fastening head; and
the bracket further comprises an aligning position and a fixing position; when the bracket is located at the aligning position, the fastening head is inserted through the aligning hole of the bracket; when the bracket is located at the fixing position, the fastener is screwed in such that the fastening head abuts against the bracket.

In one embodiment, the mounting portion is provided with a slotted hole which communicates the aligning hole with the second mounting hole.

In one embodiment, a center of the aligning hole and a center of the second mounting hole are set in a straight line.

In one embodiment, a center of the aligning hole and a center of the second mounting hole are set in an arc.

In one embodiment, a block protruding downward is configured around the aligning hole of the mounting portion, in order to prevent the fastener from returning back from the second mounting hole to the aligning hole, causing the bracket to fall; and
the block comprises a gap corresponding to the slotted hole, with a width of the gap smaller than the diameter of the stopper.

In one embodiment, a block protruding downward is configured around the aligning hole of the mounting portion, in order to prevent the fastener from returning back from the second mounting hole to the aligning hole, causing the bracket to fall; and
the block comprises a gap corresponding to the slotted hole, with a width of the gap smaller than the diameter of the fastening head.

In one embodiment, the fastener is a locking bolt, and internal threads are configured within the first mounting hole to mate with external threads of the locking bolt for screwing.

In one embodiment, there are two mounting portions, which are respectively configured on two opposite sides of the bracket; and there are two fasteners, which are respectively pre-installed on two opposite sides of the junction box.

Another aspect of the present disclosure relates to a ceiling fan, comprising the above-mentioned quick-mounting bracket structure.

### BRIEF DESCRIPTION OF DRAWINGS

The specific embodiments of the present disclosure are further explained in detail in accordance with the accompanying drawings, wherein:

FIG. 1 depicts a perspective view of the quick-mounting bracket structure according to Example 1 of the present disclosure, wherein the bracket is located at the aligning position;

FIG. 2 depicts a perspective view of the quick-mounting bracket structure according to Example 1 of the present disclosure, wherein the bracket is located at the fixing position;

FIG. 3 depicts a section view of the quick-mounting bracket structure according to Example 1 of the present disclosure, wherein the bracket is located at the aligning position;

FIG. 4 depicts a bottom view of the quick-mounting bracket structure according to Example 1 of the present disclosure, wherein the bracket is located at the aligning position;

FIG. 5 depicts a section view of the quick-mounting bracket structure according to Example 1 of the present disclosure;

FIG. 6 depicts a bottom view of the quick-mounting bracket structure according to Example 1 of the present disclosure, wherein the bracket is located at the fixing position; and

FIG. 7 depicts section view of the quick-mounting bracket structure according to Example 1 of the present disclosure, wherein the bracket is located at the fixing position.

Reference numbers:

10—junction box, 110—first mounting hole, 20—fastener, 210—fastening head, 220—fastening shaft, 230—gasket, 30—stopper, 40—bracket, 410—mounting portion, 411—aligning hole, 412—second mounting hole, 413—slotted hole, 414—block, 4141—gap.

### DETAILED DESCRIPTION OF THE INVENTION

The preferred examples of the present disclosure are explained hereinafter in combination with the accompanying drawings. It should be understood that the preferred examples described herein are only for the purpose of illustrating and explaining the present disclosure and are not intended to limit the present disclosure.

To explain the present disclosure better, the present disclosure is further described in detail hereinafter referring to the accompanying drawings.

It should be noted that the described examples are only some embodiments of the present disclosure and are not intended to be exhaustive. Based on the examples in the embodiments of the present disclosure, all other examples obtained by one skilled in the art without creative works shall fall within the scope of the embodiments of the present disclosure.

The terms used in the example of the present disclosure are for the sole purpose of describing the particular example and are not intended to limit the example of the present disclosure. Unless the context clearly indicates otherwise, the terms “a”, “said” and “the” in the singular form as used in the example of the present disclosure and the accompanying claims are also intended to include the majority form. It should also be understood that the term “and/or” used herein refers to any or all possible combinations of one or more associated listed items. The terms “up”, “upper”, or “upward” used herein refer to a direction oriented facing the ceiling, and the terms “down”, “lower”, “downward” used herein refer to a direction oriented away from the ceiling.

Unless otherwise indicated, the same reference numbers represent the same or similar elements in different drawings when the drawings are described in the following. The examples described in the following exemplary embodiments do not represent all embodiments consistent with the present disclosure. Rather, they are merely examples of devices and methods that are consistent with some aspects of the present disclosure as detailed in the accompanying claims. In the description of the present disclosure, it is to be understood that the terms “first”, “second”, “third”, etc., are used only to distinguish similar objects and are not necessarily used to describe a particular order or precedence, nor can they be understood to indicate or imply relative importance. For one skilled in the art, the specific meaning of the above terms in the present disclosure may be understood on a specific condition.

Moreover, unless otherwise indicated, the term “more” herein refers to two or more than two. The term “and/or” describes the relationship of the associated object, indicating that there can be three kinds of relationships, for example, A and/or B, is interpreted as only A, A and B, and only B. The notation “/” is generally interpreted as “or”.

In the prior art, the bracket is lifted to the bottom of the junction box which is typically pre-installed within the ceiling by the installer. Two sets of threaded holes are employed for fixation. First, a first set of threaded holes is aligned and screwed in by a bolt, followed by alignment and screwing in of another bolt for the other set of threaded holes. Finally, both of bolts are screwed and fixed simultaneously. This installing method can be inconvenient and time-consuming for installers during installation.

### Example 1

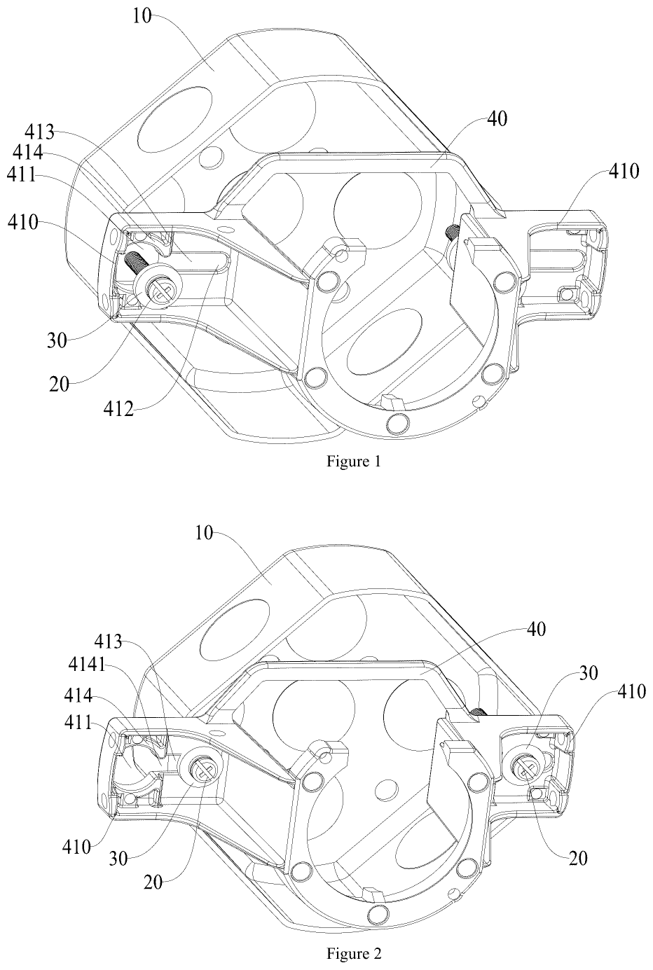

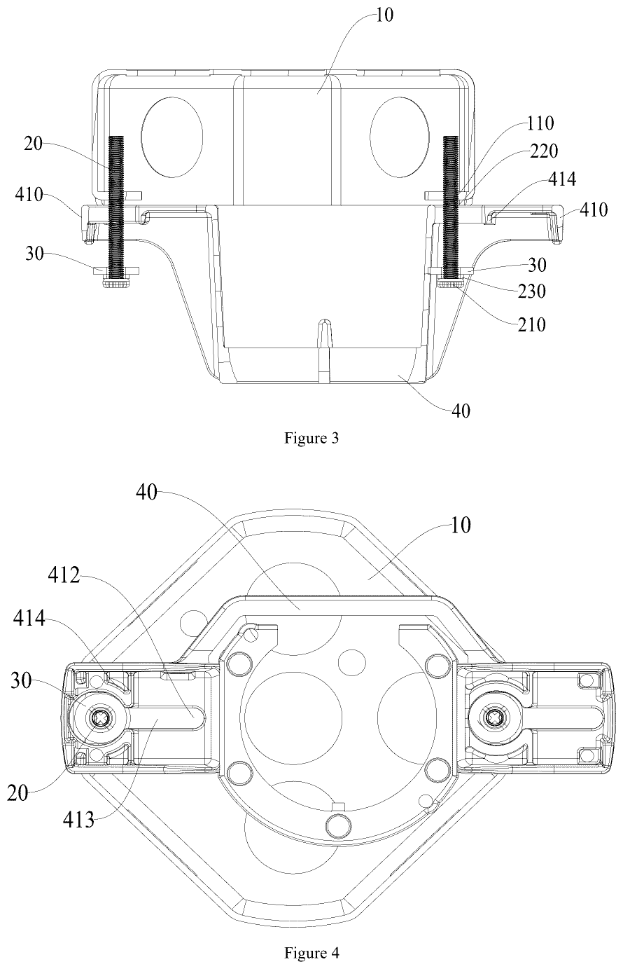

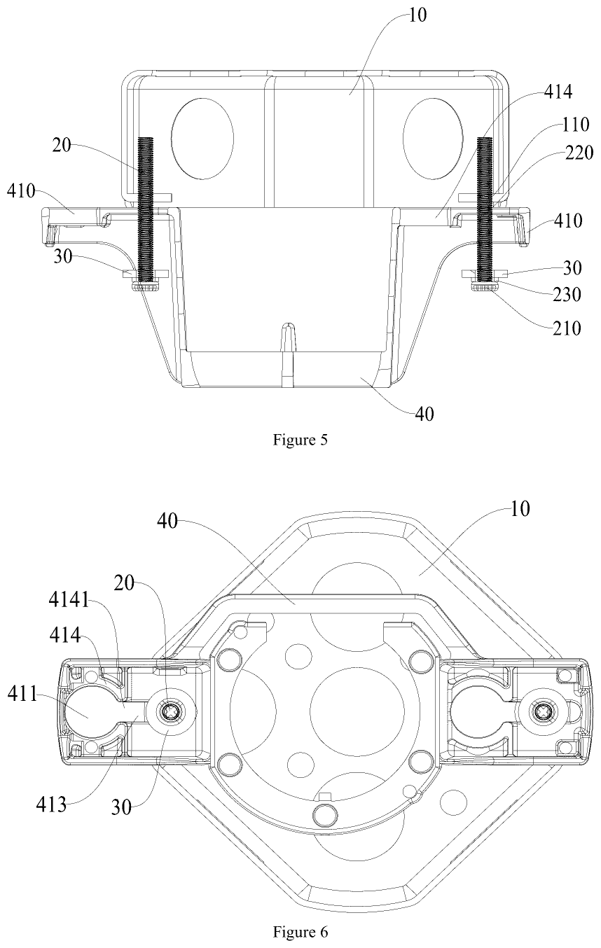

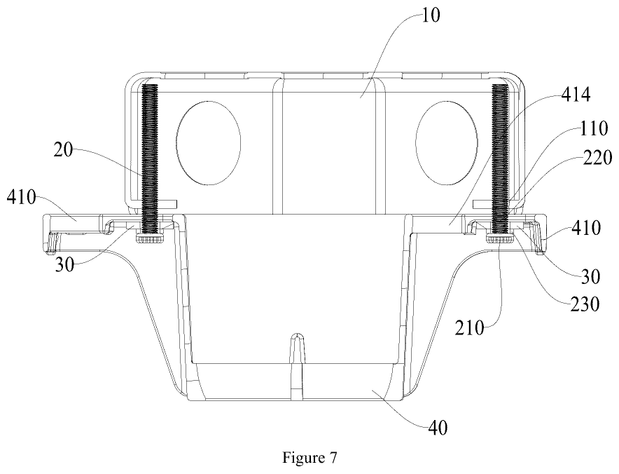

Referring to FIGS. 1 to 7, the present disclosure provides a quick-mounting bracket structure, comprising a junction box 10 provided with a first mounting hole 110; a fastener 20, comprising a fastening head 210 and a fastening shaft 220, wherein a bottom end of the fastening shaft 220 is pre-installed within the first mounting hole 110; a stopper 30 fitted over the fastening shaft 220; a bracket 40 provided with a mounting portion 410 where an aligning hole 411 and a second mounting hole 412 communicating with the aligning hole 411 are provided, wherein a diameter of the aligning hole 411 is no less than that of the stopper 30, and a diameter of the second mounting hole 412 is less than that of the stopper 30; and the bracket 40 further comprises an aligning position and a fixing position for the junction box 10; and when the bracket 40 is located at the fixing position, the fastener 20 is screwed in such that an upper surface of the stopper 30 abuts against the bracket 40 and the lower surface of the stopper 30 abuts against the fastening head 210.

The process of installing and fixing the bracket 40 to the junction box 10 involves the following steps. Initially, the fastener 20 is pre-installed within the first mounting hole 110 of the junction box 10, and then the stopper 30 and the fastening head 210 are inserted through the aligning hole 411 of the bracket 40, such that the bracket 40 is located at the aligning position. Subsequently, the bracket 40 is moved from the aligning position to the fixing position. Finally, the fastener 20 is screwed in such that the upper surface of the stopper 30 abuts against the bracket 40 and the lower surface of the stopper 30 abuts against the fastening head 210. The advantage of the present disclosure is achieved by pre-installing the fastener 20 in the junction box 10, then simply installing the bracket 40 onto the junction box 10 and finally fixing the fastener 20, thereby enabling quick installation. Moreover, this eliminates the process of aligning the threaded hole and then screwing in the whole bolt in the prior art, simplifying the installation, enhancing convenience for installers and reducing installation time.

It should be noted that the diameter of the aligning hole 411 is no less than the diameter of the stopper 30, which means the diameter of the aligning hole 411 is larger than or equal to the diameter of the stopper 30, such that the fastening head 210 of the fastener 20 pre-installed in the first mounting hole 110 is capable of being inserted through the aligning hole 411 when the bracket 40 is at the aligning position.

Preferably, the diameter of the aligning hole 411 is larger than that of the stopper 30, such that the fastening head 210 may be easily inserted through the aligning hole 411 to facilitate alignment. In contrast to the prior art, the present disclosure adopts the aligning hole 411 with a larger diameter for alignment, so as to facilitate the alignment after the installer lifts the junction box 10.

Preferably, in one example, there are two mounting portions 410, which are respectively configured on two opposite sides of the bracket 40; and there are two fasteners 20, which are respectively configured on two opposite sides of the junction box 10, such that two mounting positions are used to connect the bracket 40 with the junction box 10 and enhance stability.

Further, a center of the aligning hole 411 and a center of the second mounting hole 412 are set in a straight line. When the bracket 40 is moved from the aligning position to the fixing position, the installer only needs to move the bracket 40 horizontally, such that the fastener 20 located in the aligning hole 411 can be moved to the second mounting hole 412 with such simple movement. In other examples, the installer may also vertically or diagonally move the bracket 40, depending on the relative position of the aligning hole 411 and the second mounting hole 412.

Further, the mounting portion 410 is configured with a slotted hole 413 which communicates the aligning hole 411 with the second mounting hole 412. The aligning hole 411 is communicated with the second mounting hole 412 through the slotted hole 413 such that the bracket 40 can adapt to the installation of junction boxes 10 in different sizes. For example, the distance between two aligning holes 411 respectively configured on two mounting portions 410 is assigned as d1 and the distance between the two fasteners 20 respectively pre-installed within two first mounting holes 110 is assigned as d2. When d1 is equal to d2, two fasteners 20 can be aligned to their corresponding aligning holes 411 simultaneously. They can then be moved through the slotted holes 413 to their corresponding second mounting holes 412 to complete the installation of bracket 40 and junction box 10. When d1 is not equal to d2, one fastener 20 can be aligned to one aligning hole 411 first. Subsequently, the fastener 20 is moved through the slotted hole 413 to the second mounting hole 412, and meanwhile the position of another fastener 20 corresponding to another aligning hole 411 can be adjusted, and finally the installation of bracket 40 to the junction box 10 can be completed.

Preferably, the fastener may be fixed in the slotted hole.

Preferably, a block 414 protruding downward is configured around the aligning hole 411 of the mounting portion 410, in order to prevent the fastener 20 from returning back to the aligning hole 411 through the second mounting hole 412, causing the bracket 40 to fall. The block comprises a gap 4141 corresponding to the slotted hole 413, with a width of the gap 4141 smaller than the diameter of the stopper 30. When the fastener 20 loosens and moves towards the aligning hole 411, the fastener 20 will be blocked by the block 414, preventing the fastener 20 from returning back and avoiding potential injuries caused by the bracket 40 falling.

Preferably, the fastener 20 is a locking bolt, wherein the fastening head 210 is a bolt head and the fastening shaft 220 is a bolt shank. Internal threads are configured within the first mounting hole 110 to mate with external threads of the locking bolt for screwing. Installers may rotate the bolt head to screw the fastening shaft 220 into the first mounting hole 110.

Preferably, a gasket 230 is configured between the fastening head 210 and the stopper 30, so as to increase the contact area and friction, effectively preventing the fastener 20 from loosening.

### Example 2

The technical solution of this example is basically the same as that of Example 1, except that in this example, the center of the aligning hole 411 and the center of the second mounting hole 412 are set on an arc. The above-mentioned aligning hole 411 and the second mounting hole 412 are designed to position on an arc. Once the aligning hole 411 of the bracket 40 is aligned with the fastener 20 pre-installed on the junction box 10, the fastener 20 can be moved from the aligning hole 411 to the second mounting hole 412 by rotating the bracket 40, such that the bracket is moved from the aligning position to the fixing position. Finally, the fastener 20 is screwed in such that an upper surface of the stopper 30 abuts the bracket 40 and a lower surface of the stopper 30 abuts the fastening head 210, to achieve the installation and fixation of the bracket 40 to the junction box 10.

### Example 3

The technical solution of this example is basically the same as that of Example 1, except that, the stopper is not used in this example, but the fastening head 210 is used for restricting the movement of the fastener 20 and preventing the fastener 20 from loosening. This example provides a quick-mounting bracket structure, including a junction box 10 with a first mounting hole 110; a fastener 20 comprising a fastening head 210 and a fastening shaft 220, wherein a bottom end of the fastening shaft 220 is pre-installed within the first mounting hole 110; a bracket 40 provided with a mounting portion 410, where an aligning hole 411 and a second mounting hole 412 communicating with the aligning hole 411 are provided, wherein a diameter of the aligning hole 411 is no less than that of the fastening head 210, and a diameter of the second mounting hole 412 is less than that of the fastening head 210; and the bracket 40 further comprises an aligning position and a fixing position; and when the bracket 40 is in the fixing position, the bracket 40 abuts against the fastening head 210 by fastening the fastener 20.

In this example, the process of installing and fixing the bracket 40 to the junction box 10 involves the following steps. Initially, the fastener 20 is pre-installed within the first mounting hole 110 of the junction box 10, and then the fastener 20 is inserted through the aligning hole 411 of the bracket 40, such that the bracket 40 is located at the aligning position. Then, the bracket 40 is moved from the aligning position to the fixing position. Finally, the fastener 20 is screwed in and fixed till an upper surface of the fastening head 210 abuts against the bracket 40. The advantage of the present disclosure is achieved by pre-installing the fastener 20 in the junction box 10, then simply installing the bracket 40 onto the junction box 10 and finally fixing the fastener 20, thereby enabling quick installation. Moreover, this eliminates the process of aligning the threaded hole and then screwing in the whole bolt in the prior art, simplifying the installation, enhancing convenience for installers and reducing installation time.

It should be noted that, in this example, the diameter of the aligning hole 411 is no less than the that of the fastening head 210, which means the diameter of the aligning hole 411 is larger than or equal to that of the fastening head 210. This allows the fastening head 210 of the fastener 20 pre-installed within the first mounting hole 110 to being inserted through the aligning hole 411 when the bracket 40 is at the aligning position.

In some embodiments, there are two mounting portions 410, which are respectively disposed on two opposite sides of the bracket 40, and two fasteners 20, which are respectively disposed on two opposite sides of the junction box 10, such that two mounting positions are used to realize the installation and fixation of the bracket 40 to the junction box, which enhance the stability of the bracket

In some embodiments, the center of the aligning hole 411 and the center of the second mounting hole 412 are set on a straight line. When the bracket 40 is moved from the aligning position to the fixing position, the installer only needs to horizontally move the bracket 40 such that the fastener 20 is moved from the aligning hole 411 to the second mounting hole 412 with simple movement. In other embodiments, the installer may also vertically or diagonally move the bracket 40, depending on the relative position of the aligning hole 411 and the second mounting hole 412.

In some embodiments, the mounting portion 410 is configured with a slotted hole 413, which communicates the aligning hole 411 with the second mounting hole 412.

To prevent the fastening head 210 from returning from the second mounting hole 412 back to the aligning hole 411, causing the bracket 40 to fall, a block 414 protruding downward is configured around the aligning hole 411 of the mounting portion 410. A gap 4141 corresponding to the slotted hole 413 is configured on the block 414, with a width of the gap smaller than the diameter of the fastening head 210. When the fastener 20 loosens and moves towards the aligning hole 411, the fastening head 210 will be blocked by the block 414. This arrangement utilizes the block 414 to restrict the movement of the fastening head 210, preventing the fastener 20 from returning back and avoiding potential injuries caused by the bracket 40 falling.

Preferably, the fastener 20 is a locking bolt, wherein the fastening head 210 is a bolt head and the fastening shaft 220 is a bolt shank. Internal threads are configured within the first mounting hole 110 to mate with external threads of the locking bolt for screwing. Installers may rotate the bolt head to screw the fastening shaft 220 into the first mounting hole 110.

Preferably, a gasket 230 is configured between the bolt head and the bracket 40 to increase the contact area and friction, effectively preventing the bolt from loosening.

Preferably, a countersink bore is provided on the second mounting hole 412, for the restricting the movement of the fastening head 210.

### Example 4

The technical solution of Example 4 is basically the same as Example 3, except that in this example, the center of the aligning hole 411 and the center of the second mounting hole 412 are set on an arc.

### Example 5

The present disclosure provides a ceiling fan, comprising the above-mentioned quick-mounting bracket structure.

One skilled in the art may also make modifications and alterations to the above embodiments based on the disclosures and teachings of the above specifications. Therefore, the present disclosure is not limited to the specific embodiments disclosed and described above, and modifications and alterations to the present disclosure should also fall within the scope of the claims of the present disclosure. In addition, although some specific terms are used in this specification, these terms are only for the convenience of explanation and are not intended to be limit to the present disclosure.

Although the present disclosure has been disclosed in the form of preferred embodiments and variations thereon, it will be understood that numerous additional modifications and variations could be made thereto without departing from the scope of the disclosure.

For the sake of clarity, it is to be understood that the use of ‘a’ or ‘an’ throughout this application does not exclude a plurality, and ‘comprising’ does not exclude other steps or elements.

What is claimed is:

1. A quick-mounting bracket structure, comprising:
a junction box provided with a first mounting hole;
a fastener comprising a fastening head and a fastening shaft, wherein a bottom end of the fastening shaft is pre-installed within the first mounting hole;
a stopper fitted over the fastening shaft;
a bracket provided with a mounting portion where an aligning hole and a second mounting hole communicating with the aligning hole are provided, wherein a diameter of the aligning hole is no less than the that of the stopper, and a diameter of the second mounting hole is less than that of the stopper; and
the bracket further comprises an aligning position and a fixing position; when the bracket is located at the aligning position, the stopper and the fastening head are inserted through the aligning hole of the bracket; when the bracket is located at the fixing position, the fastener is screwed in such that an upper surface of the stopper abuts against the bracket and a lower surface of the stopper abuts against the fastening head.

2. A quick-mounting bracket structure, comprising:
a junction box provided with a first mounting hole;
a fastener comprising a fastening head and a fastening shaft, wherein a bottom end of the fastening shaft is pre-installed within the first mounting hole;
a bracket provided with a mounting portion where an aligning hole and a second mounting hole communicating with the aligning hole are provided, wherein a diameter of the aligning hole is no less than the that of the fastening head, and a diameter of the second mounting hole is less than that of the fastening head; and
the bracket further comprises an aligning position and a fixing position; when the bracket is located at the aligning position, the fastening head is inserted through the aligning hole of the bracket; when the bracket is located at the fixing position, the fastener is screwed in such that the fastening head abuts against the bracket.

3. The quick-mounting bracket structure of claim 1, wherein the mounting portion is provided with a slotted hole, which communicates the aligning hole with the second mounting hole.

4. The quick-mounting bracket structure of claim 2, wherein the mounting portion is provided with a slotted hole, which communicates the aligning hole with the second mounting hole.

5. The quick-mounting bracket structure of claim 1, wherein a center of the aligning hole and a center of the second mounting hole are set in a straight line.

6. The quick-mounting bracket structure of claim 2, wherein a center of the aligning hole and a center of the second mounting hole are set in a straight line.

7. The quick-mounting bracket structure of claim 1, wherein a center of the aligning hole and a center of the second mounting hole are set in an arc.

8. The quick-mounting bracket structure of claim 2, wherein a center of the aligning hole and a center of the second mounting hole are set in an arc.

9. The quick-mounting bracket structure of claim 3, wherein a block protruding downward is configured around the aligning hole of the mounting portion; the block comprises a gap corresponding to the slotted hole, with a width of the gap smaller than a diameter of the stopper.

10. The quick-mounting bracket structure of claim 4, wherein a block protruding downward is configured around the aligning hole of the mounting portion; the block comprises a gap corresponding to the slotted hole, with a width of the gap smaller than a diameter of the fastening head.

11. The quick-mounting bracket structure of claim 1, wherein the fastener is a locking bolt, and internal threads are configured within the first mounting hole to mate with external threads of the locking bolt for screwing.

12. The quick-mounting bracket structure of claim 2, wherein the fastener is a locking bolt, and internal threads are configured within the first mounting hole to mate with external threads of the locking bolt for screwing.

13. The quick-mounting bracket structure of claim 1, wherein there are two mounting portions, which are respectively configured on two opposite sides of the bracket; and there are two fasteners, which are respectively pre-installed on two opposite sides of the junction box.

14. The quick-mounting bracket structure of claim 1, wherein there are two mounting portions, which are respectively configured on two opposite sides of the bracket; and there are two fasteners, which are respectively pre-installed on two opposite sides of the junction box.

15. A ceiling fan, comprising the quick-mounting bracket structure of claim 1.

16. A ceiling fan, comprising the quick-mounting bracket structure of claim 2.
